(19) United States
(12) Patent Application Publication
(10) Pub. No.: US 2006/0030281 A1
(43) Pub. Date: Feb. 9, 2006

(54) Method for transmit power compensation in a mobile communication terminal and communication terminal for implementing said method

(76) Inventors: Roman Brunel, Ulm (DE); Markus Larkamp, Krefeld (DE); Martin Oelschlager, Berlin (DE); Sheng-Gen Pan, Kamp-Lintfort (DE); Reiner Pruchner, Friedrichshafen (DE); Reiner Schutze, Kamp-Lintfort (DE); Stefan Siebinger, Gunzburg (DE); Mark Skalski, Krefeld (DE)

Correspondence Address: BELL, BOYD & LLOYD, LLC, P. O. BOX 1135, CHICAGO, IL, 60690-1135, US

(21) Appl. No.: 10/534,005

(22) PCT Filed: Oct. 15, 2003
(86) PCT No.: PCT/DE03/03425

§ 371 Date: May 5, 2005

(30) Foreign Application Priority Data
Nov. 5, 2002 (DE) 102 51 465.8

(51) Int. Cl. H04B 1/04

(52) U.S. Cl. 455/127.1; 455/522

(57) ABSTRACT

The present disclosure relates to an apparatus and method for transmitting power compensation in a mobile communication terminal. Under a preferred embodiment, a terminal is equipped with a power amplifier, whose output signal amplitude is dependent upon a frequency of an input signal of the power amplifier, an HF connector, an internal antenna and a connection for an external antenna and which is designed to be operated in at least one mobile radio frequency range. The configuration aims to effectively optimize a specific absorption rate value. At least one standard mobile radio frequency range is subdivided into several frequency intervals and power compensation is carried out for at least part of the frequency intervals.

### FIELD OF TECHNOLOGY

The present disclosure relates to a method for transmission power adjustments for a mobile communications terminal that is equipped with a power amplifier, whose output signal amplitude depends on the frequency of an input signal to the power amplifier, an RF connector, an internal antenna and a connection for an external antenna, and which is designed for operation in at least one standard mobile radio frequency band. The disclosure also relates to a communications terminal by means of which the method for transmission power adjustment can be carried out.

### BACKGROUND

In order to set up a communication link by means of mobile radio terminals, such as mobile communications terminals, it is necessary for the electromagnetic waves to be transmitted via antennas to the communications terminals. The electromagnetic fields that are involved for the transmission of electromagnetic waves also penetrate into human tissue, for example in the situation when a user of a communications terminal is holding the terminal against his ear. This leads to a thermal load on the human tissue, which must be kept within permissible limits. One measure for assessment of the thermal load is the so-called “SAR value”, with the abbreviation “SAR” standing for specific absorption rate. Background information on limit values are specified in standards, such as EN 50361, IEEE Std 1528-200X.

Since the dimensions of mobile communications terminals are becoming ever smaller, power emission is concentrated over an ever narrower band. Accordingly, this can also result in an increased thermal load on the user in particular when the communications terminal is used for this purpose.

Furthermore, this also results in areas of maximum thermal load (hot spots), which determine the SAR value.

Conventional ways for reducing the SAR value has been to insert radiation-absorbent components, such as an absorber sheet, in the communications terminals. Alternatively, the dimensions of the mobile communications terminals can also be enlarged, although this influences the design of the terminals.

By way of example, the GSM specification stipulates what minimum RF output power must be available at an RF connector of a mobile communications terminal which not only has an internal antenna but is also designed for connection via the RF connector to an external antenna. In this context, it is important that the output signal amplitude of a power amplifier for a mobile communications terminal depends on the frequency of the input signal to the power amplifier. Accordingly, the antenna output power from the mobile communications terminal is frequency-dependent and channel-dependent. In order to satisfy the requirements from the GSM specification which has been mentioned here by way of example, adjustments have been made to the channel with the lowest power, so that it is possible to assume that all the channels satisfy the minimum GSM-specific power. This procedure leads to the SAR value being particularly high, for example for the channels located in the center of the frequency spectrum, assuming a typical profile for the frequency dependence of the emitted power.

For example, U.S. Pat. No. 5,995,813 Titled “Radio Telephone and Independently Controlled Booster”, which is a method for transmission power adjustment for a mobile communication terminal, that is equipped with a power amplifier. The output signal amplitude of this configuration depends on the frequency of an input signal to the power amplifier, an RF connector, an internal antenna and a connection for an external antenna, and for operation in at least one standard mobile radio frequency band, wherein the at least one standard mobile radio frequency band is subdivided into two or more frequency intervals, and power adjustment is carried out for each of at least some of the frequency intervals. Under the method described above, frequency intervals are referred to as individual radio channels.

In contrast, it has not yet been possible until now to consider the possibility of power adjustment deliberately in order to optimize the SAR value.

### BRIEF SUMMARY

Against this background, the present disclosure is based on specifying a method for power adjustment for a mobile communications terminal, in which the SAR value can be effectively optimized. A further aim is to provide a communications terminal for carrying out the method.

The power adjustment is achieved by an exemplary method for transmission power adjustments for a mobile communications terminal, which is equipped with a power amplifier whose output signal amplitude depends on the frequency of an input signal to the power amplifier, an RF connector, an internal antenna and a connection for an external antenna, and which is designed for operation in at least one standard mobile radio frequency band, in which case the at least one standard mobile radio frequency band is subdivided into two or more frequency intervals, and one power adjustment operation is carried out in each case for at least some of the frequency intervals.

Accordingly, in contrast to situations where power adjustment can be carried out only for the entire frequency band, power adjustment is additionally carried out on a frequency-interval specific basis. The frequency intervals may have the same constant width, or a varying width.

This makes it possible to adjust the power, particularly for the central frequency intervals, which further makes it possible to reduce the SAR value of the central frequency intervals, and thus to optimize it.

The power adjustment can be carried out either for all the frequency intervals into which the standard mobile radio frequency band is subdivided, or only for a number of frequency intervals, for which the emitted power from the antenna is particularly high, due to the frequency dependency of the antenna. This makes it possible to simultaneously satisfy not only any specifications for a mobile radio standard but also the requirements for an SAR value that is as low as possible.

The power adjustment for the frequency intervals can be carried out by accessing a reference table, in which an adjustment factor is associated with each frequency interval. These adjustment factors reflect the frequency profile on the power amplifier and, if appropriate the antenna characteristics. Under an exemplary embodiment, the entries in the reference table may correspond to the reciprocal of a normalized frequency profile of the power amplifier. This makes it possible to reduce the SAR value for the given frequency interval at that time.

The power adjustment for the RF connector is preferably carried out as a function of whether the mobile communications terminal is operated with its own internal antenna or with an external antenna. In the latter case, a reference table can be provided which ensures that an input signal whose amplitude is independent of frequency is produced at an input to the RF connector. As such, the appropriate specifications are taken into account.

It is also preferable to use an antenna detector to determine whether the mobile communications terminal is operating with its own internal antenna or with an external antenna, with the antenna detector responding, for example, when the internal antenna is being used, thus resulting in a situation in which the SAR value is of particular importance.

In one preferred embodiment, the power adjustment, when using the internal antenna, can be carried out such that the emitted power level from the mobile communications terminal is essentially independent of the frequency of the input signal to the power amplifier. This means that the output power from a transmission antenna for the mobile communications terminal is independent of frequency. This has the advantage that, for example, weak channels at the edge of the standard mobile radio frequency band have their power increased, to produce an improved communication link for an uplink connection to a base station.

The power is adjusted in a particularly advantageous manner by giving priority to the optimization of the SAR value over the at least one standard mobile radio frequency band.

It should be noted that the system and method in the present disclosure may, also be carried out for transmission power adjustment for a mobile communications terminal that can operate in two or more standard mobile radio frequency bands. In this case, two or more reference tables, for example, are provided, and are used in the manner described above.

The aforementioned power adjustment is achieved in a communications terminal by a mobile communications terminal having a power amplifier whose output signal amplitude depends on the frequency of the input signal to the power amplifier, and having a device for adjusting power for the output of the communications terminal in at least one standard mobile radio frequency band. In this case, the device for power adjustment is preferably designed to adjust the output power for two or more frequency intervals in the at least one standard mobile radio frequency band.

One feature of the communications terminal is that the required means for respective power adjustment are provided for individual frequency intervals in a standard mobile radio frequency band. These means may be the reference table, disclosed above. The use of an antenna detector allows different reference tables to be used for power adjustment for different operating conditions of the mobile communications terminal, with the operating conditions being distinguished on the basis of whether the antenna is external or internal.

It is noted that the software-implemented solution utilizing a reference table will be the more cost-effective, and is thus preferred overall.

### BRIEF DESCRIPTION OF THE DRAWINGS

The various objects, advantages and novel features of the present disclosure will be more readily apprehended from the following Detailed Description when read in conjunction with the enclosed drawings, in which

FIG. 1 illustrates a frequency profile of the emitted power from an antenna for a mobile communications terminal with a standard input signal amplitude;

FIG. 2 is a schematic block diagram of a transmission output stage of a mobile communications terminal, by means of which power adjustment can be carried out for individual frequency intervals, and

FIG. 3 illustrates an exemplary reference table for a triband communications terminal.

### DETAILED DESCRIPTION

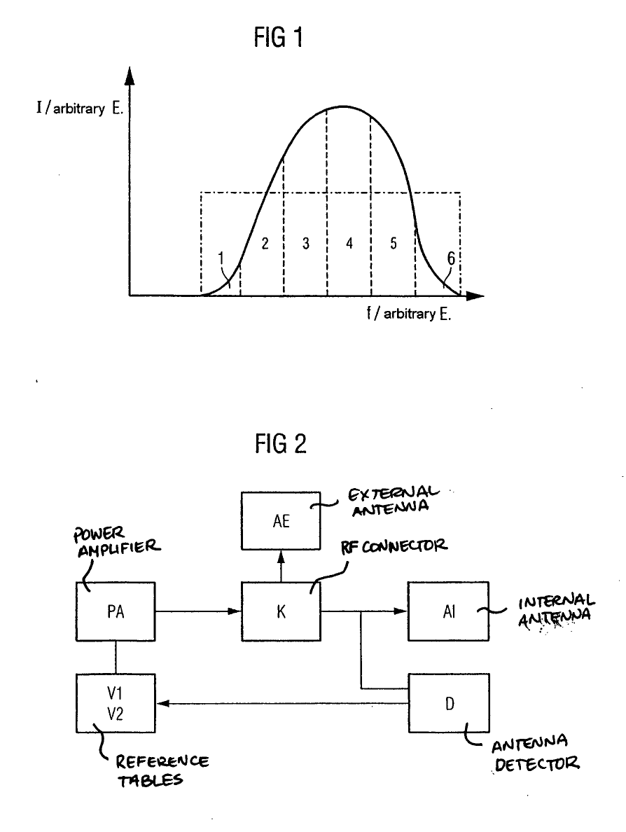

As can be seen from FIG. 1, the output power I of an antenna AI is dependent on frequency, assuming that the input signal amplitude to the power amplifier remains constant. By way of example, FIG. 1 shows a total of six frequency intervals, each indicating different mean output power levels, with the frequency interval 4 containing the power maximum. Power adjustment is carried out individually for each of the frequency intervals 1 to 6. This power adjustment is carried out such that an SAR value which is as constant as possible is set for all of the frequency intervals 1 to 6.

The frequency profile, which results after the power adjustment, for the amplitude of the output signal from the power amplifier PA is also illustrated in FIG. 1, by means of a dashed-dotted line. This clearly shows that the power adjustment results in an increase in the power for the frequency intervals or mobile radio channels 1 and 6, which are weak, so that they have a better signal-to-noise ratio when used in an uplink connection to a base station in a mobile radio network.

The separate power adjustment for all six frequency intervals furthermore means that the power that is emitted from an antenna A, and is based on the amplitude of the output signal from the power amplifier PA is reduced for particularly strong channels, such as the channels or frequency intervals 3 and 4 in FIG. 1, thus resulting in a reduction in the associated SAR value. In comparison to conventional systems, this results in a reduction in the SAR value for the strongest channels or frequency intervals on which the mobile communications terminal is operating.

For the weak frequency intervals 1 and 6, the power can be increased until the associated SAR value is slightly below a predetermined maximum SAR value, with a value range (which is predetermined by the relevant mobile radio specification) for the channel power being taken into account as a boundary condition. Overall, this results in a more uniform power capability for the mobile communications terminal over the mobile radio frequency spectrum on which it is being used at that time.

FIG. 2 shows one exemplary embodiment of a method for carrying out a power adjustment.

An output signal from power amplifier PA is passed to RF connector K, whose output signal is supplied to internal antenna AI. In the embodiment shown in FIG. 2, antenna AI is connected to antenna detector D, which continuously emits the power that is emitted from antenna AI. When antenna detector D detects that the mobile terminal is operating in an operating state with internal antenna AI, it will send a signal to reference table V2. Reference table V2 selects frequency-dependent power Adjustment, where values for RF connector K are stored in a reference table V1.

Reference table V2 is accessed when antenna detector D detects that internal antenna AI for the mobile communications terminal is being used, whose radiated power is relied upon for obtaining a SAR value. The reference table V1 contains adjustment values for the power amplifier PA which, in the end, lead to the emitted power from the communications terminal being substantially constant over the standard mobile radio spectrum that is being used at that time.

If antenna detector D finds that external antenna AE, connected to RF connector via a suitable connection, as shown in FIG. 2, reference table V1 is accessed. The adjustment values of reference table V1 are designed such that they ensure that the RF power which is provided by the power amplifier PA at an input to the RF connector is independent of frequency.

The adjustment factors in reference table V2 are chosen such that the SAR value is slightly below the predetermined maximum SAR value for all of the frequency intervals. The adjustment factors that are required for this purpose may be determined empirically.

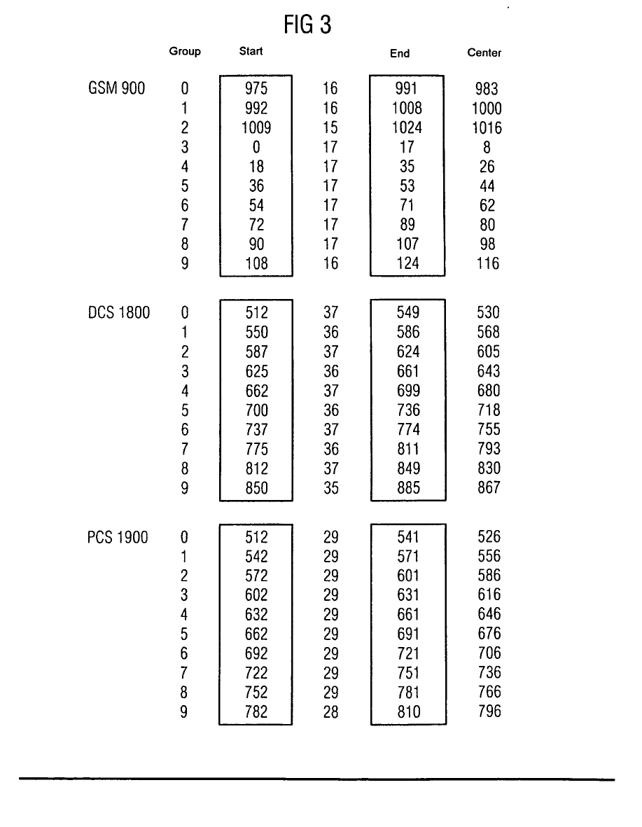

FIG. 3 shows one example of the reference table V2, with the reference table V showing a total of three standard mobile radio frequency bands, namely GSM 900, DCS 1800 and PCS 1900. Each of these frequency bands is subdivided into a total of ten groups, with the start frequency, the end frequency, the difference frequency between the end frequency and the start frequency and the center frequency being specified for each group. Each individual group in the reference table V2 has an associated adjustment value, that is obtained empirically, for example as a function of characteristics of the power amplifier and of the antenna, or of further circuit elements.

The above described description and drawings are only to be considered illustrative of exemplary embodiments, which achieve the features and advantages of the invention. Modifications and substitutions to specific process conditions and structures can be made without departing from the spirit and scope of the invention. Accordingly, the invention is not to be considered as being limited by the foregoing description and drawings, but is only limited by the scope of the appended claims.

1-10. (canceled)

11. A method for transmitting power adjustments for a mobile communications terminal, wherein said terminal comprises a power amplifier whose output signal is normally dependent on the frequency of an input signal to the power amplifier, said method comprising the steps of:
subdividing a radio frequency band into two or more frequency intervals;
detecting whether an internal or external antenna is being used in the communications terminal;
adjusting power for at least two of the frequency intervals when an external antenna is detected, wherein the applied RF power is independent of the frequency of the input signal to the power amplifier; and
adjusting power for at least two of the frequency intervals when an internal antenna is detected, wherein power emitted from the terminal is independent of the frequency of an input signal to the power amplifier.

12. The method according to claim 11, wherein the step of adjusting power for at least one of the frequency intervals comprises accessing at least one reference table, in which an adjustment factor is associated with each frequency interval.

13. A mobile communications terminal, comprising:
a power amplifier, said power amplifier receiving an input signal;
an internal antenna;
an external antenna, coupled to said terminal via an RF interface;
an antenna detector, operatively coupled to said internal and external antenna, wherein said antenna detector determines whether the internal or external antenna is being used; and
a power adjustment device operatively coupled to said antenna detector and power amplifier, wherein
the power adjustment device adjusts power for at least two frequency intervals when an external antenna is detected, wherein the applied RF power at the interface is independent of the frequency of the input signal to the power amplifier; and wherein
the power adjustment device adjusts power for at least two frequency intervals when an internal antenna is detected, wherein power emitted from the terminal is independent of the frequency of an input signal to the power amplifier.

14. The mobile communication terminal of claim 13, wherein the power adjustment device comprises at least one software-implemented reference table, in which an adjustment factor is associated with each frequency interval.
